(19) United States
(12) Patent Application Publication
(10) Pub. No.: US 2019/0334271 A1
(43) Pub. Date: Oct. 31, 2019

(54) CONTACT AND SUBSTRATE

(71) Applicant: FUJITSU LIMITED, Kawasaki-shi (JP)

(72) Inventor: Satoshi Ohsawa, Kawasaki (JP)

(73) Assignee: FUJITSU LIMITED, Kawasaki-shi (JP)

(21) Appl. No.: 16/391,835

(22) Filed: Apr. 23, 2019

(30) Foreign Application Priority Data
Apr. 26, 2018 (JP) 2018-084787

(51) Int. Cl. H01R 13/187; H01R 13/24

(52) U.S. Cl. CPC H01R 13/187; H01R 13/2421

(57) ABSTRACT

A contact includes a first metal member that includes a first tube section including a first cavity portion therein, and a plurality of first eaves portions extending from a side wall of the first tube section toward a center axis side of the first tube section, one of the plurality of first eaves portions being longer than the other first eaves portions and forming a first contact portion adapted to make contact with a first external part, a second metal member that includes a second tube section including a second cavity portion therein and being in electrical continuity with a second contact portion adapted to make contact with a second external part, and a spring extending from the first cavity portion to the second cavity portion and being accommodated in the cavity portions.

### CROSS-REFERENCE TO RELATED APPLICATION

This application is based upon and claims the benefit of priority of the prior Japanese Patent Application No. 2018-84787, filed on Apr. 26, 2018, the entire contents of which are incorporated herein by reference.

### FIELD

The embodiments discussed herein are related to a contact and a substrate.

### BACKGROUND

For measurement of electrical characteristics of a surface mounting type central processing unit (CPU) package such as land grid array (LAG) or ball grid array (BGA), a socket provided with a contact is used. For example, there has been proposed a BGA integrated circuit (IC) socket in which attachment and detachment of a BGA type IC to and from the socket are easy and the accuracy of positioning of the BGA type IC is favorable.

There may be contemplated a contact of a structure which includes a first metal member including a first contact portion, a second metal member including a second contact portion, and a spring disposed between the first metal member and the second metal member, wherein the first metal member and the second metal member make contact with each other when the spring is compressed. In such a contact, if the spring constant of the spring disposed between the first metal member and the second metal member is high, the spring is compressed under a high load which is exerted by a first external part in contact with the first metal member and a second external part in contact with the second metal member. Therefore, a great load may be exerted on at least one of the first external part and the second external part, possibly leading to breakage of the external part. On the other hand, when a spring with a low spring constant is used, the spring may be compressed by a small load, and, therefore, breakage of the first external part and the second external part may be restrained from occurring. However, the contact pressure between the first metal member and the second metal member is reduced, possibly resulting in that it is difficult to obtain a stable contact resistance and variability in resistance is enlarged.

The following is a reference document.
[Document 1] Japanese Laid-open Patent Publication No. 2002-164136.

### SUMMARY

According to an aspect of the embodiments, a contact includes a first metal member that includes a first tube section including a first cavity portion therein, and a plurality of first eaves portions extending from a side wall of the first tube section toward a center axis side of the first tube section, one of the plurality of first eaves portions being longer than the other first eaves portions and forming a first contact portion adapted to make contact with a first external part, a second metal member that includes a second tube section including a second cavity portion therein and being in electrical continuity with a second contact portion adapted to make contact with a second external part; and a spring extending from the first cavity portion to the second cavity portion and being accommodated in the cavity portions, wherein the first tube section and the second tube section make contact with each other when the spring is compressed.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1A is a sectional view of a contact according to Embodiment 1,

FIG. 1B is a plan view taken along direction A of FIG. 1A;

FIG. 1C is a plan view taken along direction B of FIG. 1A;

FIGS. 2A and 2B are sectional views of a metal member constituting a contact according to Embodiment 1;

FIG. 3 is a sectional view illustrating a state in which a contact according to Embodiment 1 is compressed in an axial direction;

FIG. 4A is a sectional view of a contact according to Comparative Example 1;

FIG. 4B is a plan view taken along direction A of FIG. 4A;

FIG. 4C is a plan view taken along direction B of FIG. 4A;

FIG. 5 is a sectional view illustrating a state in which a contact according to Comparative Example 1 is compressed in an axial direction;

FIG. 6 is a diagram for explaining characteristics of a spring used in Embodiment 1 and a spring used in Comparative Example 1;

FIG. 7 is a sectional view of a contact according to Comparative Example 2;

FIG. 8 is a diagram representing experimental results of measurement of resistance of a contact according to Comparative Example 2;

FIG. 9 is a diagram representing experimental results of measurement of resistance of a contact according to Embodiment 1;

FIGS. 10A and 10B are sectional views for explaining a problem generated in a substrate according to Comparative Example 3; and

FIG. 11 is a sectional view of a substrate according to Embodiment 2.

### DESCRIPTION OF EMBODIMENTS

Embodiments of the present disclosure will be described below, referring to the drawings.

### Embodiment 1

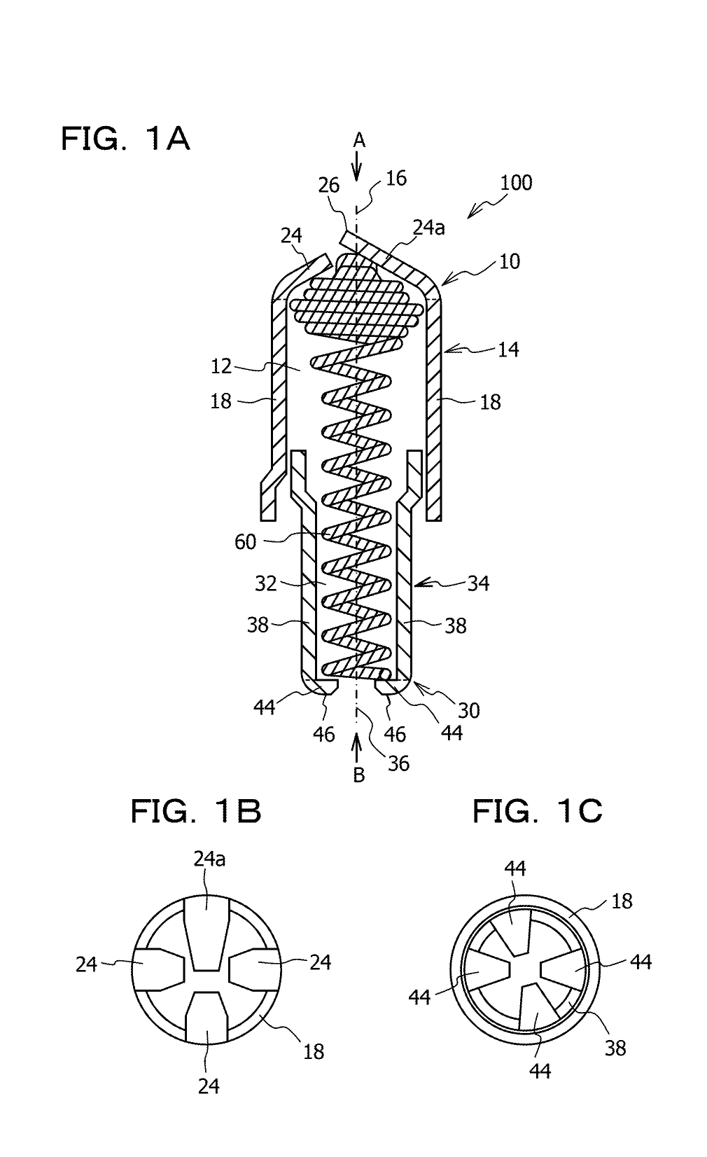

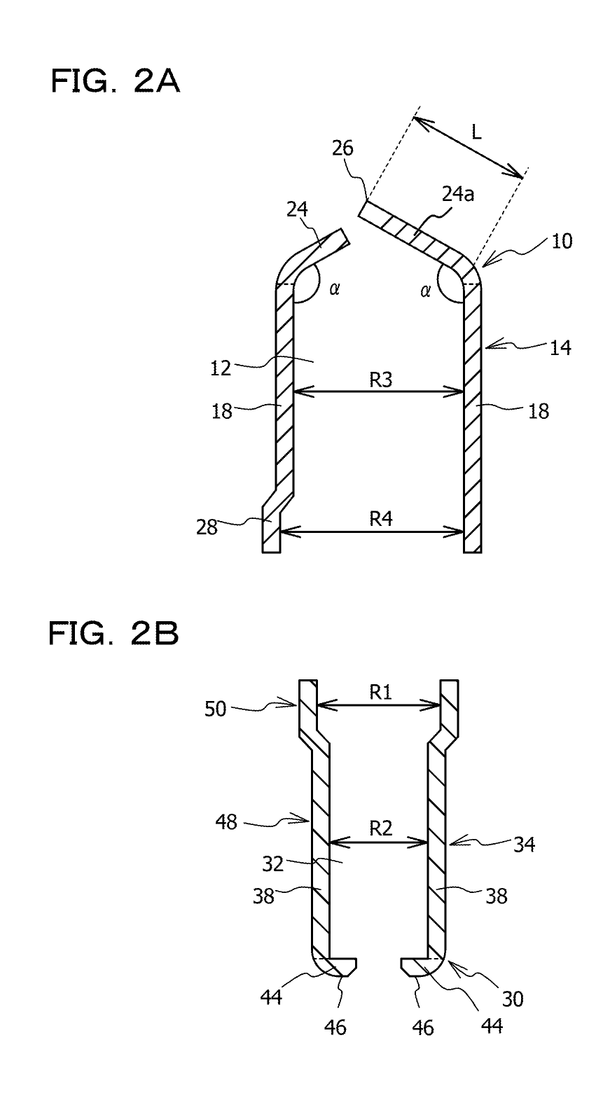

FIG. 1A is a sectional view of a contact according to Embodiment 1, FIG. 1B is a plan view taken along direction A of FIG. 1A, and FIG. 1C is a plan view taken along direction B of FIG. 1A. FIGS. 1A to 1C illustrate sectional views when the contact according to Embodiment 1 is in a free state without being compressed in an axial direction. FIGS. 2A and 2B are sectional views of a metal member constituting a contact according to Embodiment 1. As illustrated in FIG. 1A to FIGS. 2A and 2B, the contact 100 of Embodiment 1 includes a metal member 10, a metal member 30, and a spring 60. The metal members 10 and 30 are formed from a conductive metallic material, and are formed, for example, from copper having a nickel gold plated surface. The spring 60 is, for example, a compression coil spring formed from a conductive metallic material.

The metal member 10 includes a tube section 14 including a cavity portion 12 therein, and a plurality of eaves portions 24 and 24a continuously extending from the tube section 14 toward the side of a center axis 16 of the tube section 14. The tube section 14 is, for example, cylindrical in shape, but may have other shape, and may be provided with a cutout or the like in part of a side wall thereof. Note that the center axis 16 of the tube section 14 refers to a center line extending in the extending direction of the tube section 14 while passing through the center of the inside diameter of the tube section 14.

The plurality of eaves portions 24 and 24a include, for example, two sets of pairs of opposed eaves portions. The plurality of eaves portions 24 and 24a each have such a shape that the width thereof on the tip side is narrowed as compared to the width thereof on the side of a side wall 18 of the tube section 14, but may have other shape. The plurality of eaves portions 24 and 24a extend from the side wall 18 of the tube section 14 such that, for example, an angle a thereof relative to the side wall 18 of the tube section 14 is an obtuse angle. The angle a may be, for example, 135°±25°, may be 135°±20°, or may be 135°±10°. The respective angles a of the plurality of eaves portions 24 and 24a relative to the side wall 18 of the tube section 14 may be the same or different. Note that the expression that the angles a are the same includes the cases where the angles are different in an extent of production errors.

One eaves portion 24a of the plurality of eaves portions 24 and 24a is greater than the other eaves portions 24 in the length L by which the eaves portion extends from the side wall 18 of the tube section 14. The eaves portion 24a extends, for example, from the side wall 18 of the tube section 14 beyond the center axis 16 of the tube section 14, and projects more to the side opposite to the cavity portion 12 than the other eaves portions 24. This ensures that only the eaves portion 24a of the plurality of eaves portions 24 and 24a makes contact with an external part such as a CPU package. For example, the eaves portion 24a is formed with a contact portion 26 adapted to make contact with the external part. The other eaves portions 24 than the eaves portion 24a are not formed with any contact portion 26. Since the contact portion 26 is formed in the eaves portion 24a, the side wall 18 of the tube section 14 is in electrical continuity with the contact portion 26.

The metal member 30 includes a tube section 34 including a cavity portion 32 therein, and a plurality of eaves portions 44 continuously extending from the tube section 34 toward the side of a center axis 36 of the tube section 34. The tube section 34 is, for example, cylindrical in shape, but it may have other shape, and may be provided with a cutout or the like in part of a side wall thereof. Note that the center axis 36 of the tube section 34 refers to a center line extending in the extending direction of the tube section 34 while passing through the center of the inside diameter of the tube section 34. The center axis 36 of the tube section 34 substantially coincides with the center axis 16 of the tube section 14.

The tube section 34 has a stepped shape such that the inside diameter R1 thereof at an end portion on the side opposite to the eaves portion 44 is greater than the inside diameter R2 thereof on the eaves portion 44 side. The tube section 34 has a configuration in which a small-diameter portion 48 with the inside diameter R2 is longer than a large-diameter portion 50 with the inside diameter R1 in the extending direction of the tube section 34; for example, the length of the small-diameter portion 48 is approximately three to five times the length of the large-diameter portion 50.

The plurality of eaves portions 44 include, for example, two sets of pairs of opposed eaves portions. The plurality of eaves portions 44 each have such a shape that the width thereof on the tip side is narrowed as compared to the width thereof on the side of a side wall 38 of the tube section 34, but this is not limitative, and they may have other shape. The plurality of eaves portions 44 make contact with an external part such as a substrate (wiring board). Therefore, the plurality of eaves portions 44 each have a contact portion 46 adapted to make contact with the external part. Since the contact portions 46 are formed in the eaves portions 44, the side wall 38 of the tube section 34 is in electrical continuity with the contact portions 46.

The inside diameter R3 of the tube section 14 of the metal member 10 is greater than the maximum outside diameter of the tube section 34 of the metal member 30, and the metal member 30 is disposed to be located inside the metal member 10. The contact portion 26 of the metal member 10 and the contact portions 46 of the metal member 30 are in such a positional relation as to be opposed to each other through the cavity portions 12 and 32. The tube section 14 of the metal member 10 includes a bent portion 28 bent in a direction for widening the cavity portion 12, at the side wall 18 which is part of an end portion on the side opposite to the eaves portions 24 and 24a and which is located on the side opposite to the side of the eaves portion 24a. The inside diameter R4 of the tube section 14 at the bent portion 28 is greater than the inside diameter R3 of the tube section 14 at other portions.

The spring 60 extends from the cavity portion 12 of the metal member 10 to the cavity portion 32 of the metal member 30, and is accommodated in the cavity portion 12 and the cavity portion 32. The spring 60 is disposed in such a manner as to extend and contract in the direction in which the contact portion 26 of the metal member 10 and the contact portions 46 of the metal member 30 are opposed to each other. For example, the spring 60 extends while being wound helically between the contact portion 26 of the metal member 10 and the contact portions 46 of the metal member 30.

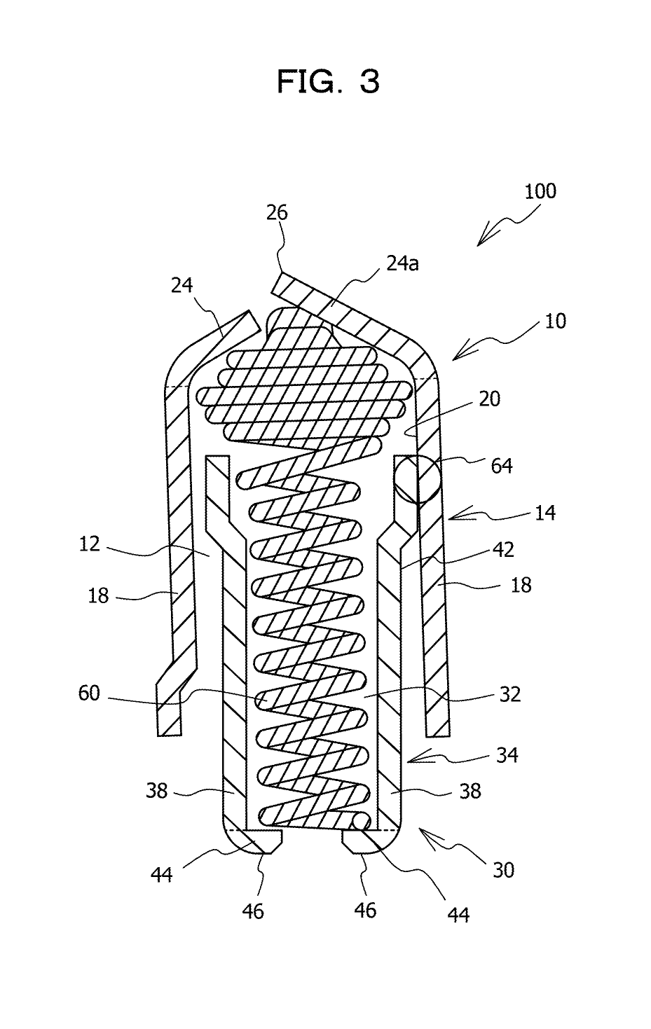

FIG. 3 is a sectional view illustrating a state in which a contact according to Embodiment 1 is compressed in an axial direction. As depicted in FIG. 3, in the contact 100 of Embodiment 1, a load is exerted by an external part in contact with the contact portion 26 of the metal member 10 and an external part in contact with the contact portions 46 of the metal member 30, whereby the spring 60 is compressed. That eaves portion 24a of the metal member 10 which is formed with the contact portion 26 is longer than the other eaves portions 24. Therefore, when the metal member 10 is pressed by the external part in contact with the eaves portion 24a, the metal member 10 is displaced toward the metal member 30 side while being obliquely inclined relative to the metal member 30. With the metal member 10 set oblique relative to the metal member 30, there is formed a contact part 64 at which the inner surface 20 of the side wall 18 of the tube section 14 of the metal member 10 and the outer surface 42 of the side wall 38 of the tube section 34 of the metal member 30 make contact with each other. When the contact part 64 is formed, the external part in contact with the contact portion 26 of the metal member 10 and the external part in contact with the contact portions 46 of the metal member 30 come into electrical continuity with each other via the metal members 10 and 30.

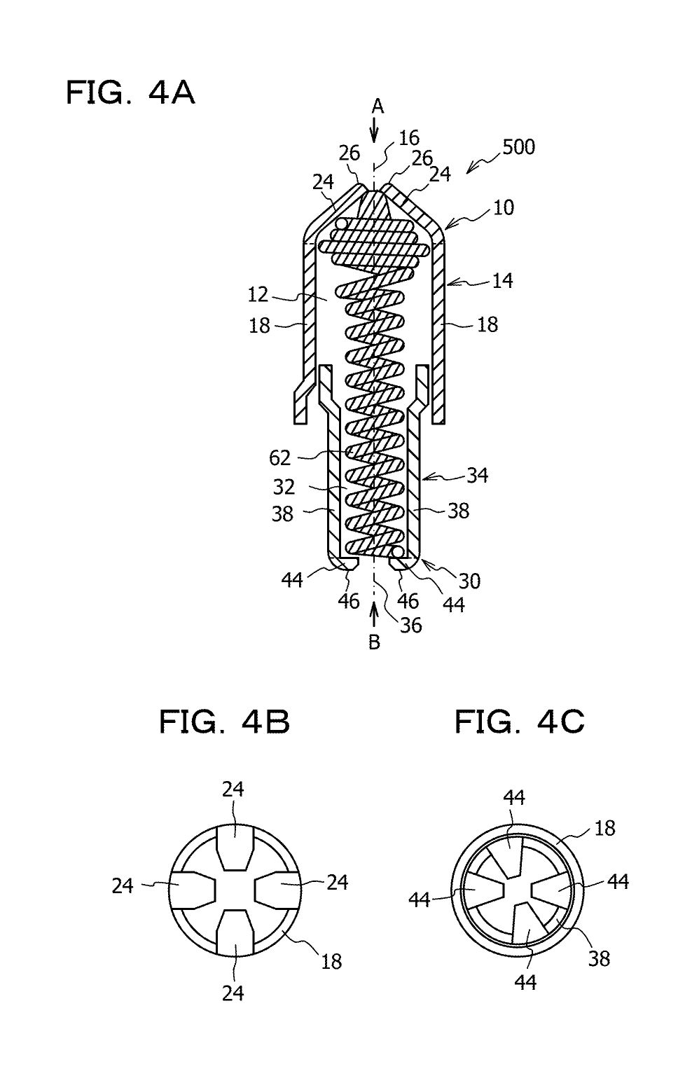

FIG. 4A is a sectional view of a contact according to Comparative Example 1, FIG. 4B is a plan view taken along direction A of FIG. 4A, and FIG. 4C is a plan view taken along direction B of FIG. 4A. FIGS. 4A to 4C represent sectional views when the contact of Comparative Example 1 is in a free state without being compressed in the axial direction. As illustrated in FIGS. 4A to 4C, in the contact 500 of Comparative Example 1, a plurality of eaves portions 24 of a metal member 10 are all the same in length from a side wall 18 of a tube section 14. Therefore, the plurality of eaves portions 24 are all formed with contact portions 26. In addition, a spring extending from a cavity portion 12 of the metal member 10 to a cavity portion 32 of a metal member 30 and being accommodated in the cavity portions is a spring 62 greater than the spring 60 in Embodiment 1 in spring constant. The other points of configuration in Comparative Example 1 are the same as those in Embodiment 1, and, therefore, descriptions of the other points are omitted.

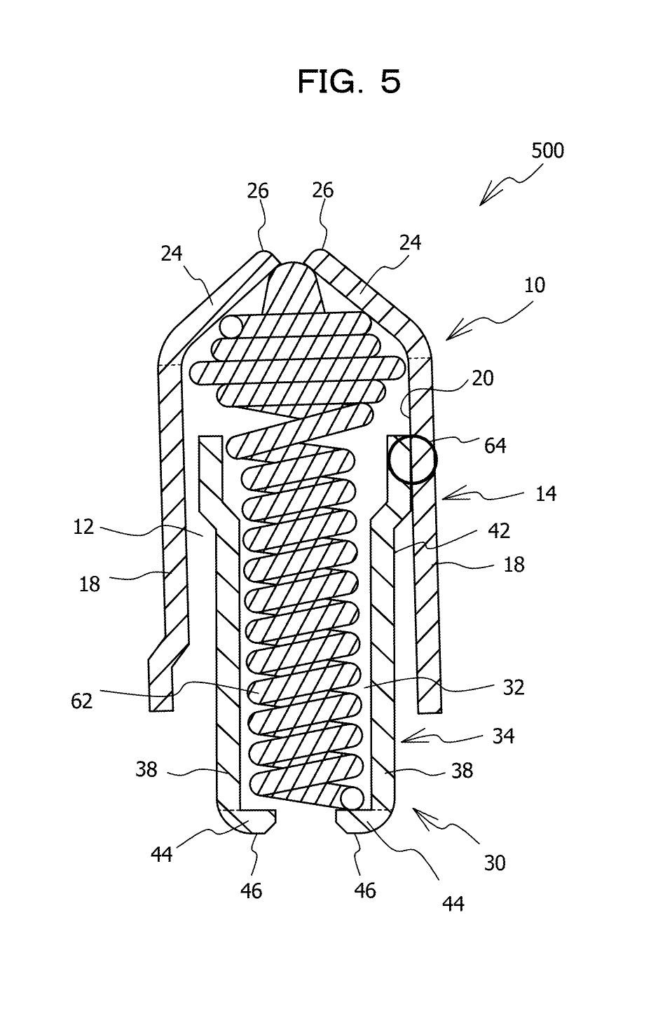

FIG. 5 is a sectional view illustrating a state in which a contact according to Comparative Example 1 is compressed in an axial direction. As depicted in FIG. 5, in the contact 500 of Comparative Example 1, also, a load is exerted by an external part in contact with a contact portions 26 of the metal member 10 and an external part in contact with contact portions 46 of the metal member 30, and the spring 62 is compressed. Even in the case where the plurality of eaves portions 24 are all formed with the contact portions 26 and the plurality of eaves portions 24 are all pressed by the external part, the metal member 10 is obliquely inclined relative to the metal member 30, and a contact part 64 is formed at which a tube section 14 of the metal member 10 and a tube section 34 of the metal member 30 make contact with each other. The reason why the metal member 10 is obliquely inclined relative to the metal member 30 even in the case where the plurality of eaves portions 24 are all pressed by the external part is considered as follows. It is considered that as the spring 62 is compressed, a repulsive force from the spring 62 increases, and the metal member 10 is obliquely inclined relative to the metal member 30 when the repulsive force reaches a certain magnitude.

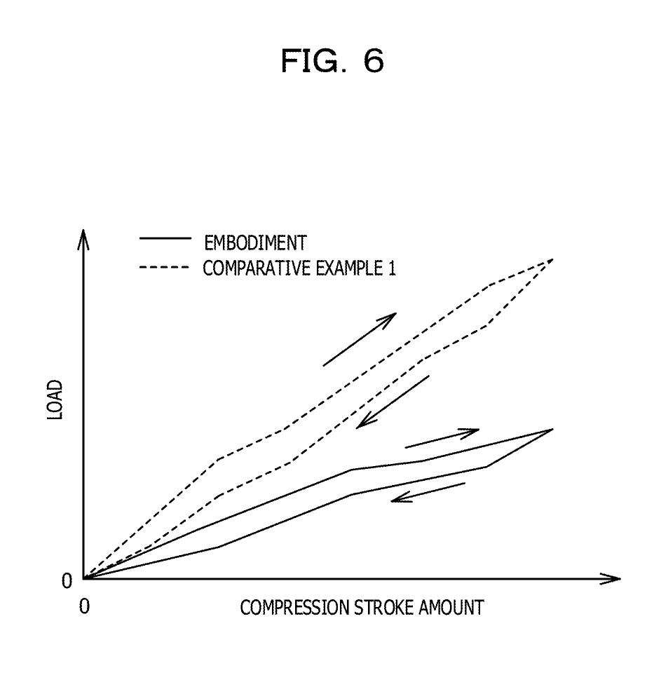

FIG. 6 is a diagram for explaining characteristics of a spring used in Embodiment 1 and a spring used in Comparative Example 1. In FIG. 6, the axis of abscissas represents compression stroke amount of the spring, and the axis of ordinates represents a load exerted on the spring. As illustrated in FIG. 6, the spring 62 used in Comparative Example 1 is great in spring constant, as compared to the spring 60 used in Embodiment 1, and, therefore, needs a larger load for obtaining the same compression stroke amount.

In Comparative Example 1, the spring 62 having a high spring constant is used. Therefore, when the spring 62 is compressed, the contact surface pressure at the contact part 64 between the tube section 14 of the metal member 10 and the tube section 34 of the metal member 30 is thereby increased, and a stable contact resistance may be obtained. However, as illustrated in FIG. 6, since the spring constant of the spring 62 used in Comparative Example 1 is high, the load to be exerted on the spring 62 for obtaining such a compression stroke amount that the tube section 14 of the metal member 10 and the tube section 34 of the metal member 30 make contact with each other is increased. For example, the external part in contact with the contact portions 26 of the metal member 10 and the external part in contact with the contact portions 46 of the metal member 30 exert large loads on the contact 500, to compress the spring 62. In this case, large loads are exerted also on the external parts, and breakage may be generated in the external parts. Such breakage of the external part is liable to be generated, for example, in the case where a multi-pin CPU package is mounted onto a socket having a plurality of contacts 500.

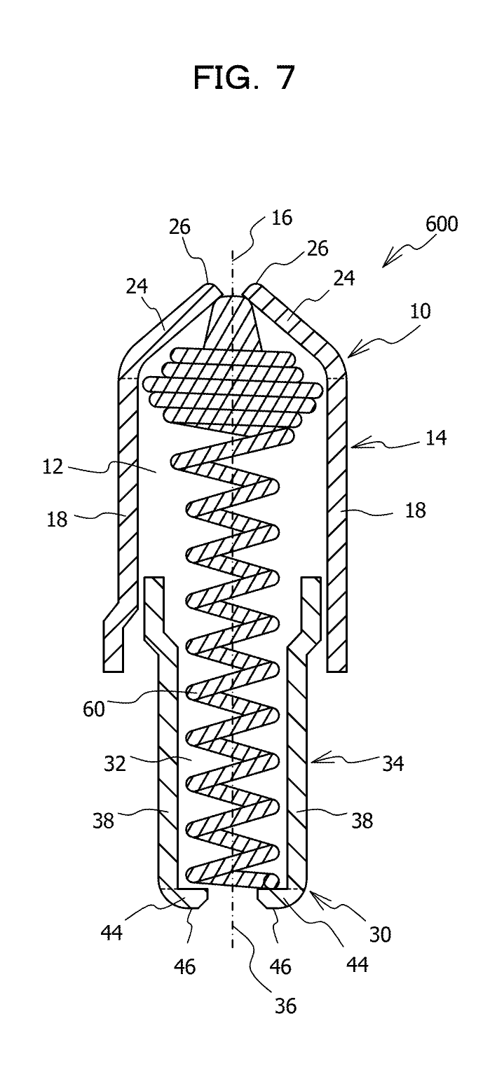

FIG. 7 is a sectional view of a contact according to Comparative Example 2. FIG. 7 represents a sectional view when the contact of Comparative Example 2 is in a free state without being compressed in the axial direction. As depicted in FIG. 7, in the contact 600 of Comparative Example 2, the spring extending from a cavity portion 12 of a metal member 10 to a cavity portion 32 of a metal member 30 and accommodated in the cavity portions is the same as the spring 60 in Embodiment 1. The other points of configuration are the same as those in Comparative Example 1, and, therefore, descriptions of the other points are omitted. In addition, the state in which the contact 600 of Comparative Example 2 is compressed in the axial direction is similar to that in FIG. 5 of Comparative Example 1, and, therefore, the state is omitted from illustration.

In Comparative Example 2, a spring 60 smaller in spring constant than the spring 62 used in Comparative Example 1 is used, and, therefore, breakage of the external part as described in Comparative Example 1 is restrained. However, since the spring 60 has a large compression stroke amount even when a small load is exerted thereon, as represented in FIG. 6, the contact surface pressure at the contact part 64 between the tube section 14 of the metal member 10 and the tube section 34 of the metal member 30 is considered to be small. In this case, it is considered difficult to obtain a stable contact resistance.

Here, an experiment in which the resistance of the contact 600 of Comparative Example 2 is measured will be described. In the experiment, a resin-made housing with the contact 600 set therein was placed on a wiring board, the contact 600 was pressed against the wiring board side by use of a load cell provided at a tip thereof with a terminal for resistance measurement, and a resistance value at the time of a given load value was measured. The measurement was repeated for each of the plurality of contacts 600. As the metal members 10 and 30 of the contact 600, members formed from copper whose surface had been subjected to a plating treatment were used.

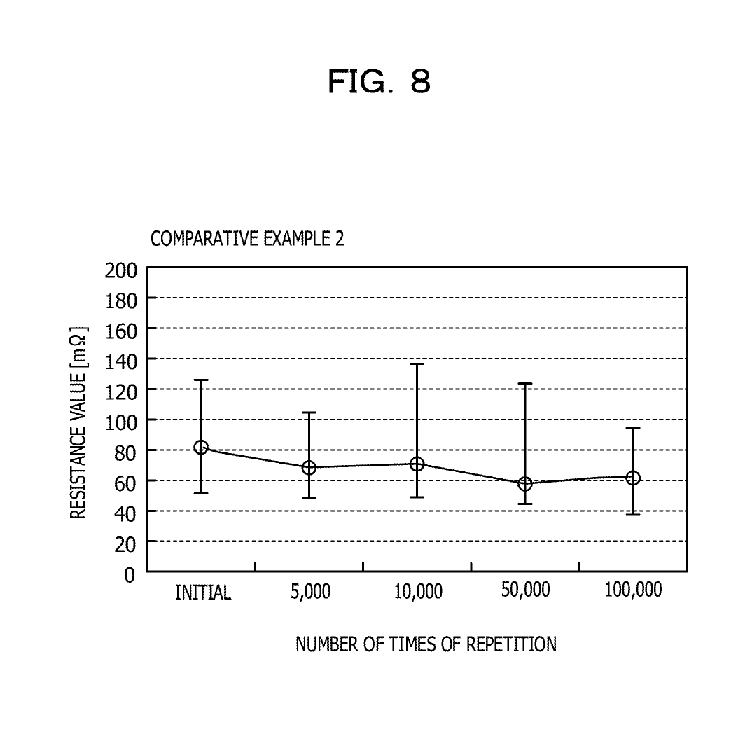

FIG. 8 is a diagram representing experimental results of measurement of resistance of a contact according to Comparative Example 2. In FIG. 8, the axis of abscissas represents the number of times the measurement was repeated, and the axis of ordinates represents resistance value. In addition, average values of measurement are represented by solid circle marks, and the variability ranges of measurements are represented by error bars. As represented in FIG. 8, the contact 600 of Comparative Example 2 gave a result of large variability ranges of resistance values.

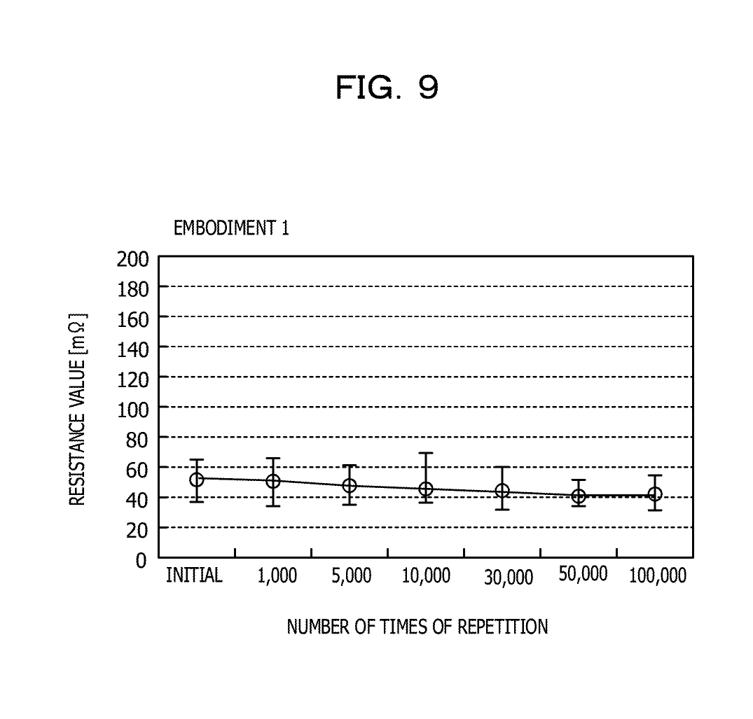

In the next place, an experiment in which resistance of the contact 100 of Embodiment 1 was measured will be described. The experiment was conducted in the same manner as for the contact 600 of Comparative Example 2. FIG. 9 is a diagram representing experimental results of measurement of resistance of a contact according to Embodiment 1. In FIG. 9, the axis of abscissas represents the number of times the measurement was repeated, and the axis of ordinates represents resistance value. Besides, average values of measurement are represented by solid circle marks, and the variability ranges of measurements are represented by error bars. As represented in FIG. 9, the contact 100 of Embodiment 1 gave a result of small variability ranges of resistance values and, hence, a stable resistance. The reason why such a stable resistance could be obtained for the contact 100 of Embodiment 1 may be considered as follows.

For example, in the contact 100 of Embodiment 1, the plurality of eaves portions 24 and 24a possessed by the metal member 10 include the eaves portion 24a which is longer than the other eaves portions 24 and is formed with the contact portion 26, the other eaves portions 24 being not formed with any contact portion 26. Therefore, when the metal member 10 is pressed by the external part in contact with the contact portion 26, the metal member 10 is displaced toward the metal member 30 side while being inclined in a fixed direction. Accordingly, the tube section 14 of the metal member 10 and the tube section 34 of the metal member 30 make contact with each other at substantially the same portion, to form the contact part 64. It is considered that as a result of this, variability in the contact resistance between the metal member 10 and the metal member 30 was reduced, and a stable resistance could be obtained. On the other hand, in the contact 600 of Comparative Example 2, the plurality of eaves portions 24 possessed by the metal member 10 are all formed with the contact portions 26. Therefore, when the metal member 10 is pressed by the external part in contact with the contact portions 26 of the metal member 10, the manner of inclination of the metal member 10 relative to the metal member 30 varies depending on, for example, the manner in which the forces are exerted at each time. For example, the tube section 14 of the metal member 10 and the tube section 34 of the metal member 30 make contact with each other at a portion which differs occasionally, to form the contact part 64. Accordingly, in the contact 600 of Comparative Example 2, variability of contact resistance between the metal member 10 and the metal member 30 is enlarged. It is considered that as a result of this, the variability in resistance was enlarged.

In addition, in the contact 100 of Embodiment 1, only the eaves portion 24a of the plurality of eaves portions 24 and 24a is pressed by the external part, and, therefore, the load from the external part is wholly exerted on the eaves portion 24a. On the other hand, in the contact 600 of Comparative Example 2, all the plurality of eaves portions 24 are pressed by the external part, and, therefore, the load from the external part is dispersed to the plurality of eaves portions 24. Accordingly, as compared to the contact 600 of Comparative Example 2, the contact 100 of Embodiment 1 has a higher contact surface pressure at the contact part 64 between the tube section 14 of the metal member 10 and the tube section 34 of the metal member 30, which leads to a stable contact resistance. This is considered to be the reason why the resistance value was stable.

According to Embodiment 1, as illustrated in FIG. 1A, the eaves portion 24a of the plurality of eaves portions 24 and 24a possessed by the metal member 10 is longer than the other eaves portions 24, and the eaves portion 24a is formed with the contact portion 26 adapted to make contact with the external part. For this reason, in the case where the eaves portion 24a is pressed by the external part, the spring 60 is thereby compressed and the metal member 10 is displaced while being inclined relative to the metal member 30, the tube section 14 of the metal member 10 and the tube section 34 of the metal member 30 make contact with each other at substantially the same portion. In addition, the load from the external part is wholly exerted on the eaves portion 24a, and, therefore, the contact surface pressure at the contact part 64 between the tube section 14 of the metal member 10 and the tube section 34 of the metal member 30 is enlarged. For these reasons, even in the case where the spring 60 having a low spring constant is used and the load exerted on the spring 60 is set small, the contact resistance at the contact part 64 may be stabilized. Consequently, a stable resistance may be obtained with a small load, as represented in FIG. 9.

As illustrated in FIG. 1A, the eaves portion 24a preferably extends from the side wall 18 of the tube section 14 beyond the center axis 16 of the tube section 14. This ensures that the metal member 10 is liable to be inclined in a fixed direction relative to the metal member 30; as a result, it is effectively realized that the tube section 14 of the metal member 10 and the tube section 34 of the metal member 30 make contact with each other at substantially the same portion. For this reason, the contact resistance at the contact part 64 between the metal member 10 and the metal member 30 may be effectively stabilized.

As depicted in FIG. 1A, it is preferable that the side wall 18 of the tube section 14 of the metal member 10 is disposed outside the side wall 38 of the tube section 34 of the metal member 30. In addition, as illustrated in FIG. 3, it is preferable that the inner surface 20 of the side wall 18 of the tube section 14 makes contact with the outer surface 42 of the side wall 38 of the tube section 34 when the spring 60 is compressed. This ensures that the tube section 14 of the metal member 10 and the tube section 34 of the metal member 30 are liable to make contact with each other in a state in which the spring 60 is sufficiently compressed, and, consequently, the contact surface pressure at the contact part 64 between the metal member 10 and the metal member 30 may be enlarged.

As illustrated in FIGS. 2A and 2B, it is preferable that the inside diameter R2, on the side opposite to the metal member 10, of the tube section 34 of the metal member 30 is smaller than the inside diameter R1, on the metal member 10 side, of the tube section 34. This ensures that as depicted in FIG. 3, it may be effectively realized that the tube section 14 of the metal member 10 and the tube section 34 of the metal member 30 make contact with each other in a state in which the spring 60 is sufficiently compressed. As a result, the contact surface pressure at the contact part 64 between the metal member 10 and the metal member 30 may be enlarged.

As illustrated in FIGS. 1A and 2, it is preferable that of the tube section 14 of the metal member 10, the side wall 18 which is part of an end portion on the metal member 30 side and which is located on the side opposite to the eaves portion 24a is bent in the direction for spacing away from the cavity portion 12. This ensures that when the spring 60 is compressed and the metal member 10 is displaced toward the metal member 30 side, as depicted in FIG. 3, the end portion of the tube section 14 of the metal member 10 is restrained from making contact with the tube section 34 of the metal member 30, and the spring 60 may be compressed sufficiently. Therefore, the contact surface pressure at the contact part 64 between the metal member 10 and the metal member 30 may be enhanced.

As illustrated in FIGS. 1A to 1C, it is preferable that the metal member 30 includes the plurality of eaves portions 44 for forming the contact portions 46, in addition to that the metal member 10 includes the plurality of eaves portions 24 and 24a. This ensures that the spring 60 accommodated in the cavity portion 12 of the metal member 10 and the cavity portion 32 of the metal member 30 may be restrained from leaping out to the exterior.

### Embodiment 2

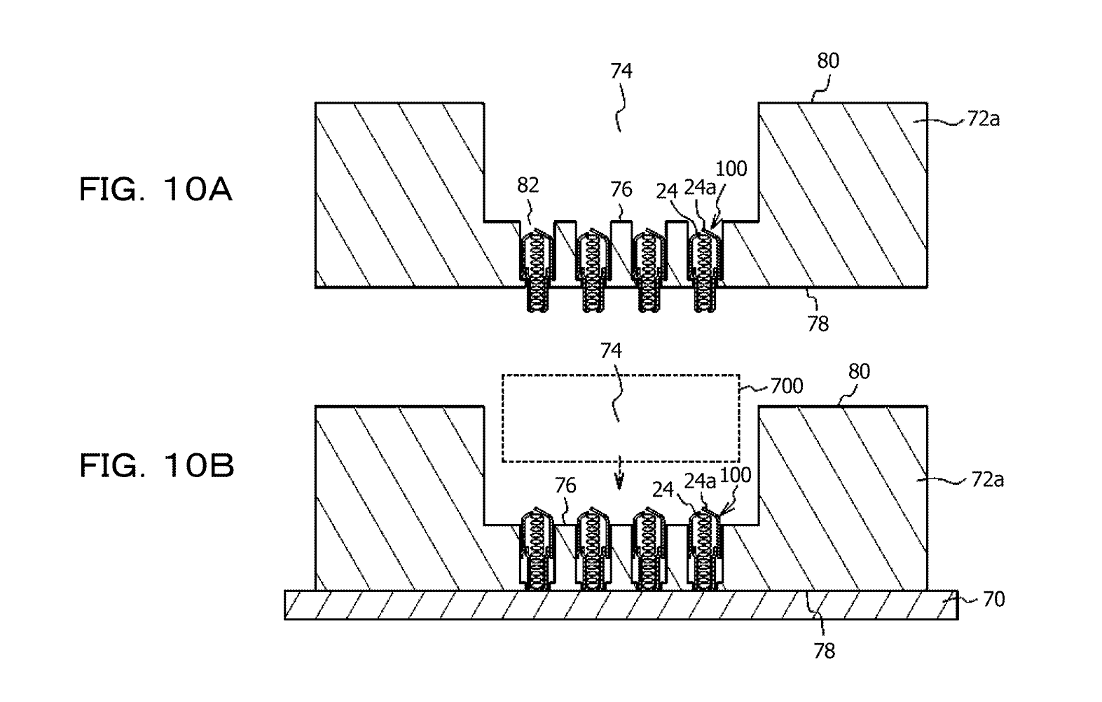

Embodiment 2 is an example of a substrate on an upper surface of which a socket provided with the contact 100 of Embodiment 1 is mounted. In the first place, a problem generated in a substrate according to Comparative Example 3 will be described. FIGS. 10A and 10B are sectional views for explaining a problem generated in a substrate according to Comparative Example 3. FIG. 10A is a view illustrating a state before a socket 72a provided with the contacts 100 is mounted on a substrate 70, and FIG. 10B is a view illustrating a state after the socket 72a is mounted on the substrate 70.

As illustrated in FIG. 10A, the socket 72a is provided with a recess 74 in which to mount an external part such as a CPU package. A bottom surface 76 of the recess 74 is provided with a plurality of through-holes 82 penetrating the socket 72a to a lower surface 78 of the socket 72a. The contact 100 of Embodiment 1 is inserted in each of the plurality of through-holes 82. The through-holes 82 each have a stepped portion at which the inside diameter varies. The contact 100 is retained in the through-hole 82 by being caught on the stepped portion formed in the through-hole 82. The contacts 100 protrude downward from the lower surface 78 of the socket 72a, but do not protrude upward from the bottom surface 76 of the recess 74.

When the socket 72a provided with the contacts 100 is mounted on the substrate 70, as depicted in FIG. 10B, the contacts 100 are pressed by the substrate 70, to protrude upward beyond the bottom surface 76 of the recess 74. In the recess 74, an external part 700 is mounted. At the time of mounting of the external part 700, the external part 700 is liable to be caught on the eaves portions 24a, since the eaves portions 24a of the contacts 100 are longer and projecting more as compared to the other eaves portions 24. As a result, the eaves portions 24a may be deformed and/or broken. In view of this, a substrate of Embodiment 2 that is able to restrain such deformation and/or breakage of the eaves portions 24a will be described.

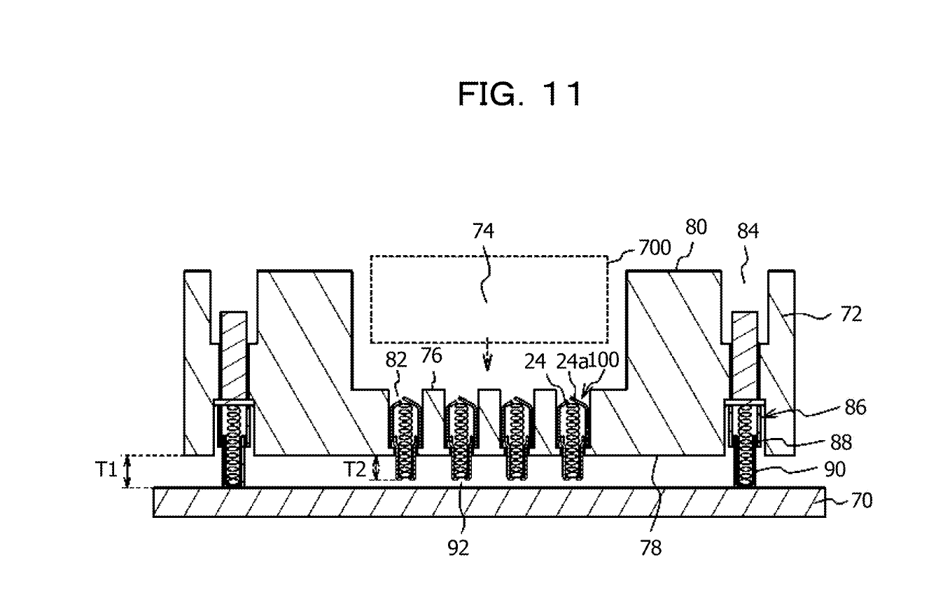

FIG. 11 is a sectional view of a substrate according to Embodiment 2. As illustrated in FIG. 11, the substrate 70 of Embodiment 2 has, mounted on its upper surface, a socket 72 provided with the contacts 100 of Embodiment 1. The socket 72 is provided with the recess 74, like the socket 72a of Comparative Example 3, and the bottom surface 76 of the recess 74 is provided with the plurality of through-holes 82. The contact 100 is inserted in each of the plurality of through-holes 82. Further, the socket 72 is provided with lifting-up pins 86 inserted in through-holes 84 which penetrate the socket 72 from an upper surface 80 to a lower surface 78 of the socket 72. The lifting-up pin 86 is provided therein with a spring 88, and a tip portion 90 thereof may be made to advance and retreat by extension and contraction of the spring 88.

In a state in which the socket 72 is mounted on the upper surface of the substrate 70 and the external part 700 is not mounted in the recess 74, the protrusion amount T1 of the lifting-up pins 86 from the lower surface 78 of the socket 72 is equal to or greater than the protrusion amount T2 of the contacts 100. The protrusion amount T1 of the lifting-up pins 86 is, for example, around 2 mm, whereas the protrusion amount T2 of the contacts 100 is, for example, around 1 mm. Gaps 92 may be formed between the contacts 100 and the substrate 70. With the protrusion amount T1 of the lifting-up pins 86 equal to or greater than the protrusion amount T2 of the contacts 100, it is ensured that the contacts 100 are not pressed by the substrate 70, and do not protrude upward beyond the bottom surface 76 of the recess 74.

According to Embodiment 2, in a state in which the external part 700 is not mounted on the socket 72, as depicted in FIG. 11, the protrusion amount T1 of the lifting-up pins 86 from the lower surface 78 of the socket 72 is equal to or greater than the protrusion amount T2 of the contacts 100. This restrains the contacts 100 from protruding upward from the through-holes 82 provided in the socket 72. Therefore, at the time of mounting the external part 700 in the recess 74 of the socket 72, the external part 700 may be restrained from being caught on the eaves portions 24a, and deformation and/or breakage of the eaves portions 24a may be restrained from occurring. In the state in which the external part 700 is not mounted on the socket 72, the contacts 100 may be in contact with the upper surface of the substrate 70. However, it is preferable that the contacts 100 are not in contact with the upper surface of the substrate 70 in the state in which the external part 700 is not mounted on the socket 72, in order that the contacts 100 are restrained from protruding upward from the through-holes 82 provided in the socket 72.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A contact comprising:
a first metal member that includes a first tube section including a first cavity portion therein, and a plurality of first eaves portions extending from a side wall of the first tube section toward a center axis side of the first tube section, one of the plurality of first eaves portions being longer than the other first eaves portions and forming a first contact portion adapted to make contact with a first external part;
a second metal member that includes a second tube section including a second cavity portion therein and being in electrical continuity with a second contact portion adapted to make contact with a second external part; and
a spring extending from the first cavity portion to the second cavity portion and being accommodated in the cavity portions,
wherein the first tube section and the second tube section make contact with each other when the spring is compressed.

2. The contact according to claim 1,
wherein the one first eaves portion forming the first contact portion extends from the side wall of the first tube section beyond a center axis of the first tube section.

3. The contact according to claim 1,
wherein the side wall of the first tube section is disposed outside of a side wall of the second tube section, and an inner surface of the side wall of the first tube section makes contact with an outer surface of the side wall of the second tube section when the spring is compressed.

4. The contact according to claim 3,
wherein an inside diameter of the second tube section on a side opposite to the first metal member is smaller than an inside diameter of the second tube section on a first metal member side.

5. The contact according to claim 1,
wherein of the first tube section, a side wall being part of an end portion on a second metal member side and being located on a side opposite to the one first eaves portion forming the first contact portion is bent in a direction for spacing away from the first cavity portion.

6. The contact according to claim 1,
wherein the second metal member includes a plurality of second eaves portions that extend from a side wall of the second tube section toward a center axis side of the second tube section and that each form the second contact portion.

7. The contact according to claim 1,
wherein the plurality of first eaves portions extend from the side wall of the first tube section such that an angle of each of the plurality of first eaves portions relative to the side wall of the first tube section is an obtuse angle.

8. The contact according to claim 7,
wherein the angle is 135°±25°.

9. The contact according to claim 6,
wherein the plurality of second eaves portions are equal in length.

10. The contact according to claim 1,
wherein the spring is a compression coil spring.

11. A substrate on an upper surface of which a socket provided with a contact is mounted,
wherein the contact includes
a first metal member that includes a first tube section including a first cavity portion therein, and a plurality of first eaves portions extending from a side wall of the first tube section toward a center axis side of the first tube section, one of the plurality of first eaves portions being longer than the other first eaves portions and forming a first contact portion adapted to make contact with an external part,
a second metal member that includes a second tube section including a second cavity portion therein and being in electrical continuity with a second contact portion adapted to make contact with the substrate, and
a spring extending from the first cavity portion to the second cavity portion and being accommodated in the cavity portions,
the first tube section and the second tube section make contact with each other when the spring is compressed, and
the socket includes a lifting-up pin that protrudes from a lower surface of the socket with a protrusion amount equal to or greater than a protrusion amount of the contact from the lower surface of the socket, in a state in which the external part adapted to make contact with the first contact portion of the contact is not mounted on the socket.

12. The substrate according to claim 11,
wherein the contact is not in contact with an upper surface of the substrate, in a state in which the external part is not mounted on the socket.
